(19) United States
(12) Patent Application Publication
(10) Pub. No.: US 2025/0056393 A1
(43) Pub. Date: Feb. 13, 2025

(54) CONFIGURATION INFORMATION FOR INITIAL ACCESS

(71) Applicant: QUALCOMM Incorporated, San Diego, CA (US)

(72) Inventors: Ahmed ELSHAFIE, San Diego, CA (US); Alexandros MANOLAKOS, Athens (GR); Hung Dinh LY, San Diego, CA (US)

(21) Appl. No.: 18/718,589

(22) PCT Filed: Feb. 16, 2023
(86) PCT No.: PCT/US2023/062751

§ 371 Date: Jun. 11, 2024

(30) Foreign Application Priority Data
Feb. 24, 2022 (GR) 20220100166

(51) Int. Cl. H04W 48/18

(52) U.S. Cl. CPC H04W 48/18

(57) ABSTRACT

Various aspects of the present disclosure generally elate to wireless communication. In some aspects, a network node may receive, from a network entity in connection with an access procedure, information indicative of at least one of a security capability or an energy transfer or charging capability. The network node may connect to the network entity to obtain network access based on the security capability or the energy transfer or charging capability. Numerous other aspects are described.

### CROSS-REFERENCE TO RELATED APPLICATION

This patent application claims priority to Greece Patent Application No. 20220100166, filed on Feb. 24, 2022, entitled “CONFIGURATION INFORMATION FOR INITIAL ACCESS,” and assigned to the assignee hereof. The disclosure of the prior application is considered part of and is incorporated by reference into this patent application in its entirety.

### FIELD OF THE DISCLOSURE

Aspects of the present disclosure generally relate to wireless communication and to techniques and apparatuses for configuration information for initial access.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a network node. The method may include receiving, from a network entity in connection with an access procedure, information indicative of at least one of a security capability or an energy transfer or charging capability. The method may include connecting to the network entity to obtain network access based on the security capability or the energy transfer or charging capability.

Some aspects described herein relate to a method of wireless communication performed by a network entity. The method may include transmitting, to a network node in connection with an access procedure, information indicative of at least one of a security capability or an energy transfer or charging capability. The method may include connecting to the network node to provide network access based on the security capability or the energy transfer or charging capability.

Some aspects described herein relate to a network node for wireless communication. The user equipment may include a memory and one or more processors coupled to the memory. The one or more processors may be configured to receive, from a network entity in connection with an access procedure, information indicative of at least one of a security capability or an energy transfer or charging capability. The one or more processors may be configured to connect to the network entity to obtain network access based on the security capability or the energy transfer or charging capability.

Some aspects described herein relate to a network entity for wireless communication. The network entity may include a memory and one or more processors coupled to the memory. The one or more processors may be configured to transmit, to a network node in connection with an access procedure, information indicative of at least one of a security capability or an energy transfer or charging capability. The one or more processors may be configured to connect to the network node to provide network access based on the security capability or the energy transfer or charging capability.

Some aspects described herein relate to a non-transitory computer-readable medium that stores a set of instructions for wireless communication by a network node. The set of instructions, when executed by one or more processors of the network node, may cause the network node to receive, from a network entity in connection with an access procedure, information indicative of at least one of a security capability or an energy transfer or charging capability. The set of instructions, when executed by one or more processors of the network node, may cause the network node to connect to the network entity to obtain network access based on the security capability or the energy transfer or charging capability.

Some aspects described herein relate to a non-transitory computer-readable medium that stores a set of instructions for wireless communication by a network entity. The set of instructions, when executed by one or more processors of the network entity, may cause the network entity to transmit, to a network node in connection with an access procedure, information indicative of at least one of a security capability or an energy transfer or charging capability. The set of instructions, when executed by one or more processors of the network entity, may cause the network entity to connect to the network node to provide network access based on the security capability or the energy transfer or charging capability.

Some aspects described herein relate to an apparatus for wireless communication. The apparatus may include means for receiving, from a network entity in connection with an access procedure, information indicative of at least one of a security capability or an energy transfer or charging capability. The apparatus may include means for connecting to the network entity to obtain network access based on the security capability or the energy transfer or charging capability.

Some aspects described herein relate to an apparatus for wireless communication. The apparatus may include means for transmitting, to a network node in connection with an access procedure, information indicative of at least one of a security capability or an energy transfer or charging capability. The apparatus may include means for connecting to the network node to provide network access based on the security capability or the energy transfer or charging capability.

The foregoing broadly outlines example features and example technical advantages of examples according to the disclosure. Additional example features and example advantages are described herein.

### BRIEF DESCRIPTION OF THE DRAWINGS

The drawings illustrate certain example aspects of this disclosure and are therefore not limiting in scope. The same reference numbers in different drawings may identify the same or similar elements.

FIG. 1 is a diagram illustrating an example of a wireless network, in accordance with the present disclosure.

FIG. 2 is a diagram illustrating an example of abase station in communication with a user equipment (UE) in a wireless network, in accordance with the present disclosure.

FIG. 3 is a diagram illustrating an example of a four-step random access procedure, in accordance with the present disclosure.

FIG. 4 is a diagram illustrating an example of a two-step random access procedure, in accordance with the present disclosure.

FIG. 5 is a diagram illustrating an example of a synchronization signal (SS) hierarchy, in accordance with the present disclosure.

FIG. 6 is a diagram illustrating an example of sidelink communications and access link communications in the presence of an intercepting communication device, in accordance with the present disclosure.

FIG. 7 is a diagram illustrating an example of intercepted communications in different communication states, in accordance with the present disclosure.

FIG. 8 is a diagram illustrating an example associated with configuration information for initial access, in accordance with the present disclosure.

FIGS. 9-10 are diagrams illustrating example processes associated with configuration information for initial access, in accordance with the present disclosure.

FIGS. 11-12 are diagrams of example apparatuses for wireless communication, in accordance with the present disclosure.

FIG. 13 is a diagram illustrating an example of a disaggregated base station architecture, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure, function, example, aspect or the like presented throughout this disclosure. This disclosure includes, for example, any structure, function, example, aspect, or the like disclosed herein, whether implemented independently of or combined with any other aspect of the disclosure. For example, an apparatus may be implemented or a method may be practiced using any number of the aspects set forth herein. In addition, the scope of the disclosure includes such an apparatus or method which is practiced using other structure, functionality, or structure and functionality in addition to or other than the various aspects of the disclosure set forth herein. Any aspect of the disclosure disclosed herein may be embodied by one or more elements of a claim.

Aspects and examples generally include a method, apparatus, node, system, computer program product, non-transitory computer-readable medium, user equipment, base station, wireless communication device, and/or processing system as described or substantially described herein with reference to and as illustrated by the drawings and specification.

This disclosure may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, are better understood from the following description when considered in connection with the accompanying figures. Each of the figures is provided for the purposes of illustration and description, and not as a definition of the limits of the claims.

While aspects are described in the present disclosure by illustration to some examples, such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). Aspects described herein may be practiced in a wide variety of devices, components, systems, distributed arrangements, and/or end-user devices of varying size, shape, and constitution.

Several aspects of telecommunication systems are presented with reference to various apparatuses and techniques. These apparatuses and techniques are described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

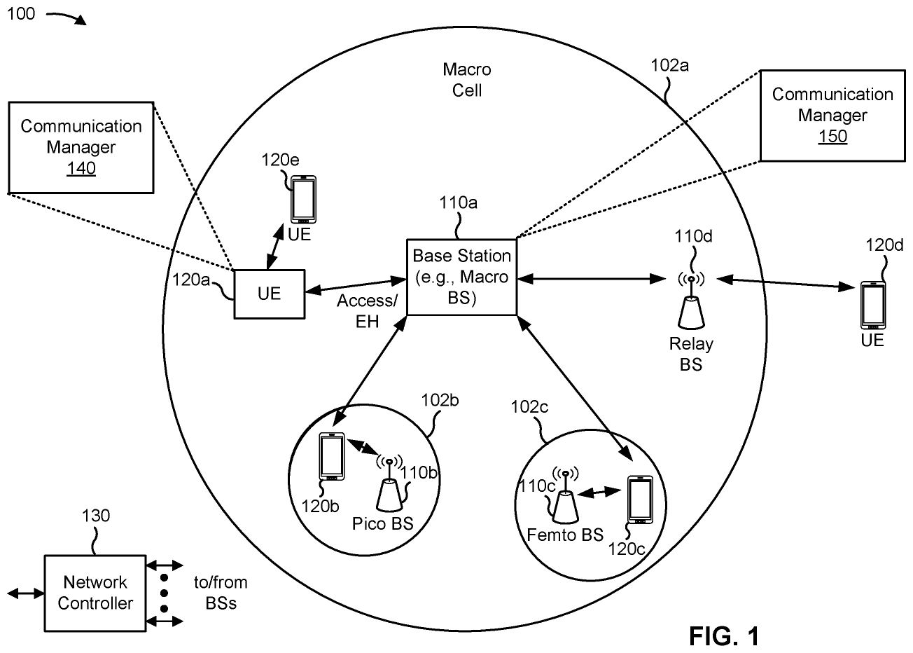

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station. Additionally, or alternatively, a wireless network may include one or more UEs that communicate with each other. For example, a first UE may communicate with a second UE via sidelink communications. “Sidelink” (or “SL”) refers to a communication link between UEs.

Abase station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 (which may also be referred to as “network nodes” in the wireless network 100 through various types of backhaul interfaces, such as a direct physical connection or a virtual network, using any transport network.

As described herein, a node, which may be referred to as a “node,” a “network node,” a “network entity,” or a “wireless node,” may include, be, be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote unit (RU), and/or another suitable processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be any other combination of devices or components. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE being configured to receive information from a base station also discloses that a first network node being configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a first one or more components, a first processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other device, system apparatus, node, or the like that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled. Some UEs 120 may have energy harvesting (EH) charging capabilities, which may also be termed an “energy transfer” capability, a “charging” capability, or an “energy transfer or charging” capability. For example, a UE 120 may obtain access from a base station 110 and charge a battery using energy transfer or charging from the base station 110, as described in more detail herein.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a network entity in connection with an access procedure, information indicative of at least one of a security capability or an energy transfer or charging capability; and connect to the network entity to obtain network access based on the security capability or the energy transfer or charging capability. Additionally, or alternatively, the communication manager 140 may perform one or more other operations described herein.

In some aspects, a network entity (e.g., the base station 110) may include a communication manager 150. As described in more detail elsewhere herein, the communication manager 150 may transmit, to a UE in connection with an access procedure, information indicative of at least one of a security capability or an energy transfer or charging capability; and connect to the UE to provide network access based on the security capability or the energy transfer or charging capability. Additionally, or alternatively, the communication manager 150 may perform one or more other operations described herein.

As indicated above, FIG. 1 is provided as an example. Other examples may differ from what is described with regard to FIG. 1.

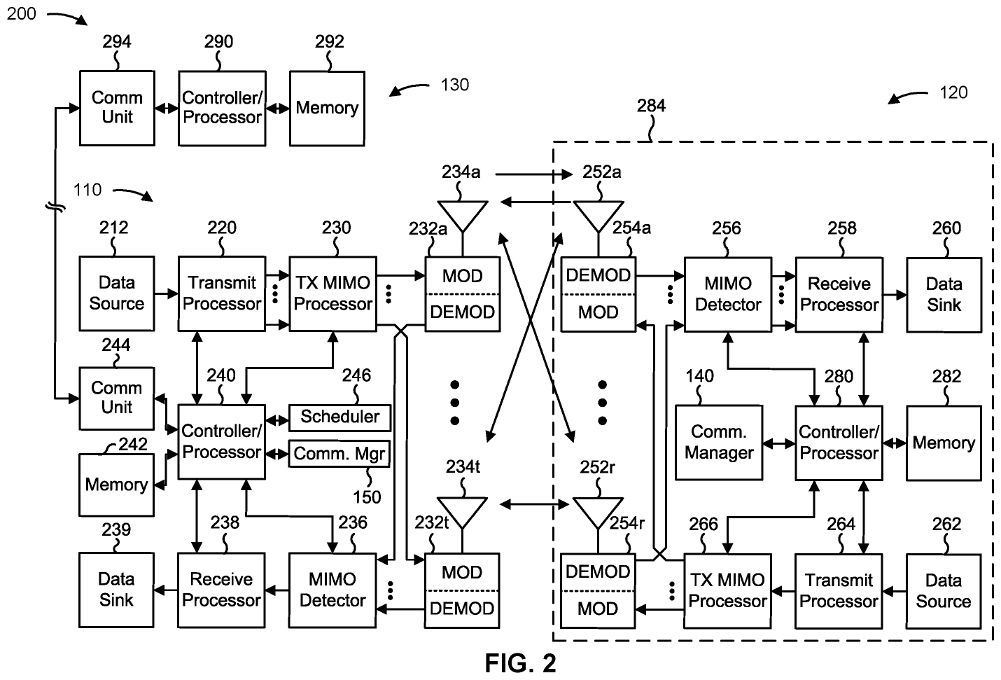

FIG. 2 is a diagram illustrating an example 200 of abase station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based on one or more channel quality indicators (CQIs) received from that UE 120. The base station 110 may process (e.g., encode and modulate) the data for the UE 120 based on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

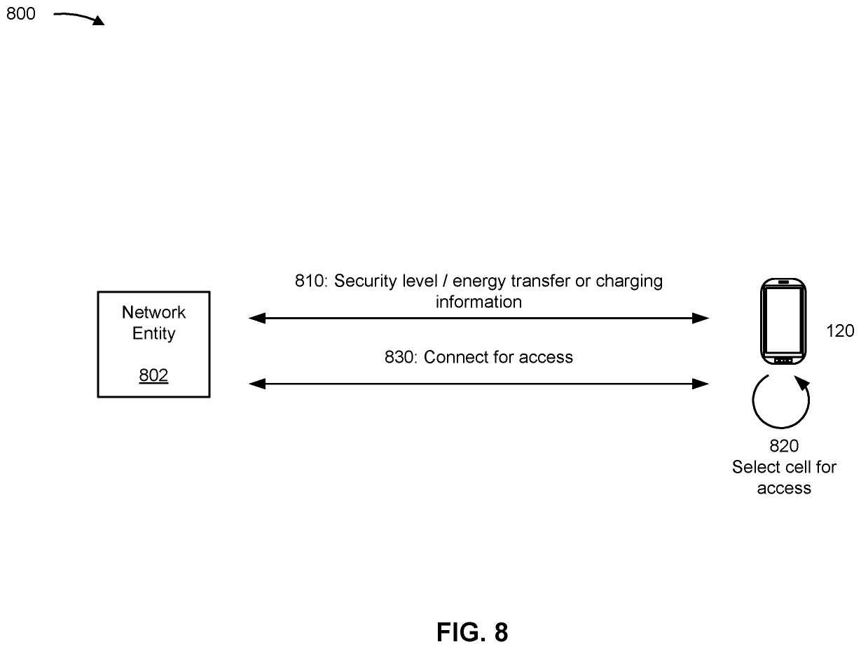

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 8-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 8-12).

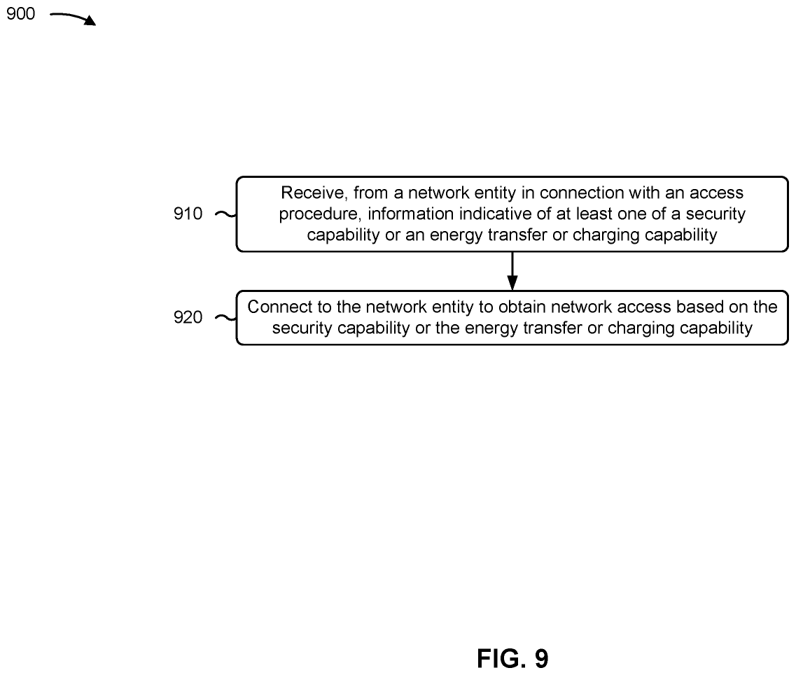

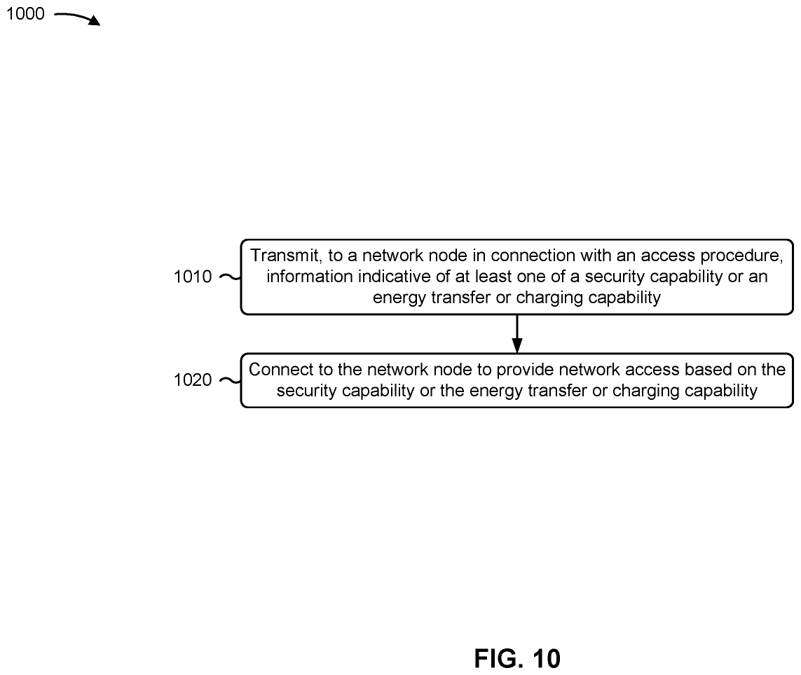

The controller/processor 240 of the base station 110, the controller/processor 280 of the UE 120, and/or any other component(s) of FIG. 2 may perform one or more techniques associated with configuration information for initial access, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving, from a network entity in connection with an access procedure, information indicative of at least one of a security capability or an energy transfer or charging capability; and/or means for connecting to the network entity to obtain network access based on the security capability or the energy transfer or charging capability. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network entity (e.g., the base station 110) includes means for transmitting, to a UE 120 in connection with an access procedure, information indicative of at least one of a security capability or an energy transfer or charging capability; and/or means for connecting to the UE to provide network access based on the security capability or the energy transfer or charging capability. The means for the network entity to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station (BS, e.g., base station 110), or one or more units (or one or more components) performing base station functionality, may be implemented in an aggregated or disaggregated architecture. For example, a BS (such as a Node B (NB), eNB, NR BS, 5G NB, access point (AP), a TRP, a cell, or the like) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual centralized unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an O-RAN (such as the network configuration sponsored by the O-RAN Alliance), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

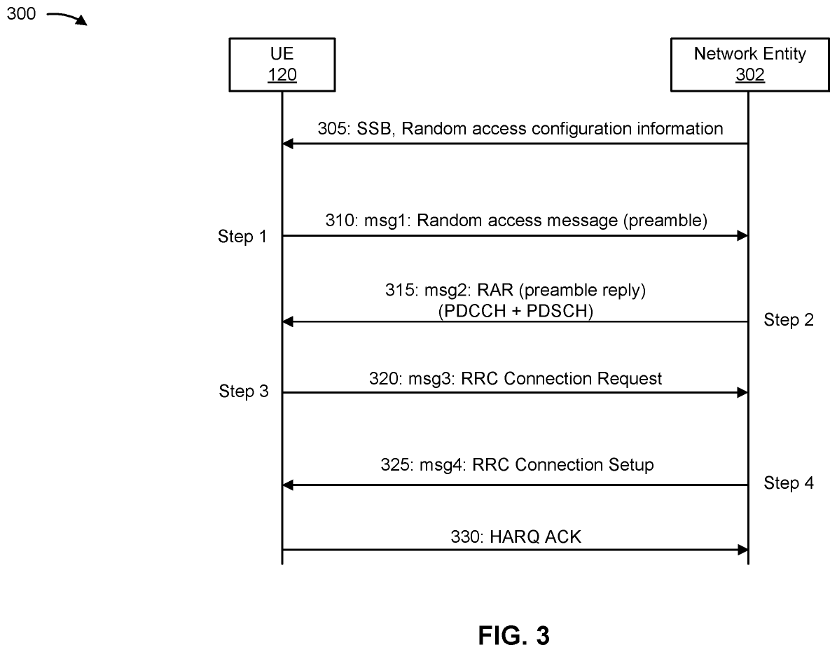

FIG. 3 is a diagram illustrating an example of a four-step random access procedure, in accordance with the present disclosure. As shown in FIG. 3, a network entity 302 and a UE 120 may communicate with one another to perform the four-step random access procedure.

As shown by reference number 305, the network entity 302 may transmit, and the UE 120 may receive, one or more synchronization signal blocks (SSBs) and random access configuration information. The random access configuration information may be transmitted in and/or indicated by system information (e.g., in one or more system information blocks (SIBs)) and/or an SSB, such as for contention-based random access. Additionally, or alternatively, the random access configuration information may be transmitted in a radio resource control (RRC) message and/or a physical downlink control channel (PDCCH) order message that triggers a random access channel (RACH) procedure, such as for contention-free random access. The random access configuration information may include one or more parameters to be used in the random access procedure, such as one or more parameters for transmitting a random access message (RAM) and/or one or more parameters for receiving a random access response (RAR).

As shown by reference number 310, the UE 120 may transmit a RAM, which may include a preamble (sometimes referred to as a random access preamble, a physical random access channel (PRACH) preamble, or a RAM preamble). The message that includes the preamble may be referred to as a message 1, msg1, MSG1, a first message, or an initial message in a four-step random access procedure. The random access message may include a random access preamble identifier.

As shown by reference number 315, the network entity 302 may transmit an RAR as a reply to the preamble. The message that includes the RAR may be referred to as message 2, msg2, MSG2, or a second message in a four-step random access procedure. The RAR may indicate the detected random access preamble identifier (e.g., received from the UE 120 in msg1). Additionally, or alternatively, the RAR may indicate a resource allocation to be used by the UE 120 to transmit message 3 (msg3).

As part of the second step of the four-step random access procedure, the network entity 302 may transmit a PDCCH communication for the RAR. The PDCCH communication may schedule a physical downlink shared channel (PDSCH) communication that includes the RAR. For example, the PDCCH communication may indicate a resource allocation for the PDSCH communication. Also as part of the second step of the four-step random access procedure, the network entity 302 may transmit the PDSCH communication for the RAR, as scheduled by the PDCCH communication. The RAR may be included in a medium access control (MAC) protocol data unit (PDU) of the PDSCH communication.

As shown by reference number 320, the UE 120 may transmit an RRC connection request message. The RRC connection request message may be referred to as message 3, msg3, MSG3, or a third message of a four-step random access procedure. The RRC connection request may include a UE identifier, uplink control information (UCI), and/or a physical uplink shared channel (PUSCH) communication (e.g., an RRC connection request).

As shown by reference number 325, the network entity 302 may transmit an RRC connection setup message. The RRC connection setup message may be referred to as message 4, msg4, MSG4, or a fourth message of a four-step random access procedure. The RRC connection setup message may include the detected UE identifier, a timing advance value, and/or contention resolution information. As shown by reference number 330, if the UE 120 successfully receives the RRC connection setup message, the UE 120 may transmit a hybrid automatic repeat request (HARQ) acknowledgment (ACK).

As indicated above, FIG. 3 is provided as an example. Other examples may differ from what is described with regard to FIG. 3.

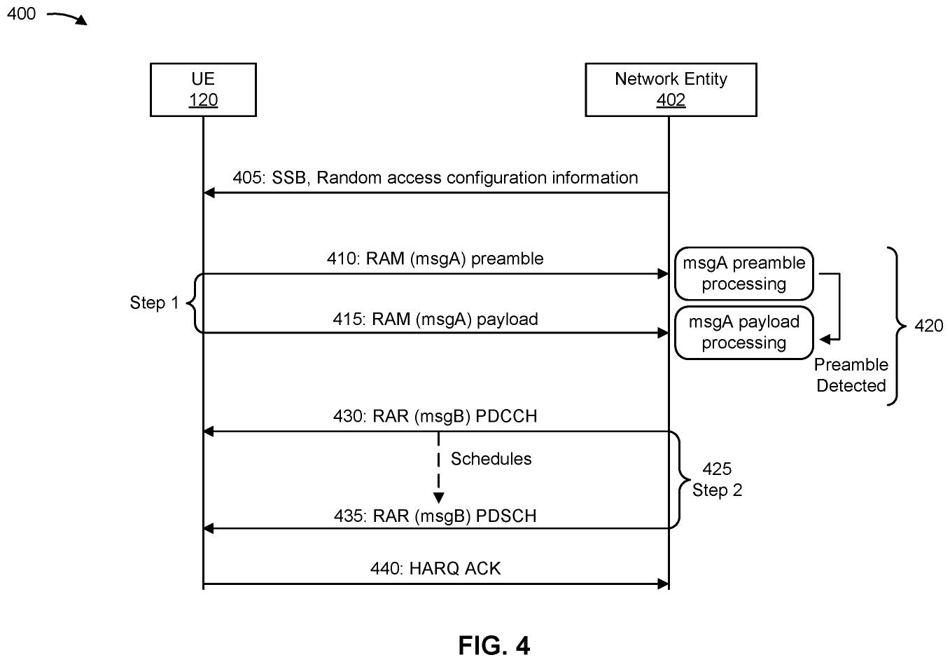

FIG. 4 is a diagram illustrating an example 400 of a two-step random access procedure, in accordance with the present disclosure. As shown in FIG. 4, a network entity 402 and a UE 120 may communicate with one another to perform the two-step random access procedure.

As shown by reference number 405, the network entity 402 may transmit, and the UE 120 may receive, one or more SSBs and random access configuration information. The random access configuration information may be transmitted in and/or indicated by system information (e.g., in one or more SIBs) and/or an SSB, such as for contention-based random access. Additionally, or alternatively, the random access configuration information may be transmitted in a RRC message and/or a PDCCH order message that triggers a RACH procedure, such as for contention-free random access. The random access configuration information may include one or more parameters to be used in the two-step random access procedure, such as one or more parameters for transmitting an RAM and/or receiving an RAR to the RAM.

As shown by reference number 410, the UE 120 may transmit, and the network entity 402 may receive, a RAM preamble. As shown by reference number 415, the UE 120 may transmit, and the network entity 402 may receive, a RAM payload. As shown, the UE 120 may transmit the RAM preamble and the RAM payload to the network entity 402 as part of an initial (or first) step of the two-step random access procedure. The RAM may be referred to as message A, msgA, a first message, or an initial message in a two-step random access procedure. Furthermore, the RAM preamble may be referred to as a message A preamble, a msgA preamble, a preamble, or a PRACH preamble, and the RAM payload may be referred to as a message A payload, a msgA payload, or a payload. The RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, UCI, and/or a PUSCH transmission).

As shown by reference number 420, the network entity 402 may receive the RAM preamble transmitted by the UE 120. If the network entity 402 successfully receives and decodes the RAM preamble, the network entity 402 may then receive and decode the RAM payload.

As shown by reference number 425, the network entity 402 may transmit an RAR (sometimes referred to as an RAR message). As shown, the network entity 402 may transmit the RAR message as part of a second step of the two-step random access procedure. The RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, and/or contention resolution information.

As shown by reference number 430, as part of the second step of the two-step random access procedure, the network entity 402 may transmit a PDCCH communication for the RAR. The PDCCH communication may schedule a PDSCH communication that includes the RAR. For example, the PDCCH communication may indicate a resource allocation (e.g., in downlink control information (DCI)) for the PDSCH communication.

As shown by reference number 435, as part of the second step of the two-step random access procedure, the network entity 402 may transmit the PDSCH communication for the RAR, as scheduled by the PDCCH communication. The RAR may be included in a MAC PDU of the PDSCH communication. As shown by reference number 440, if the UE 120 successfully receives the RAR, the UE 120 may transmit a HARQ ACK.

As indicated above, FIG. 4 is provided as an example. Other examples may differ from what is described with regard to FIG. 4.

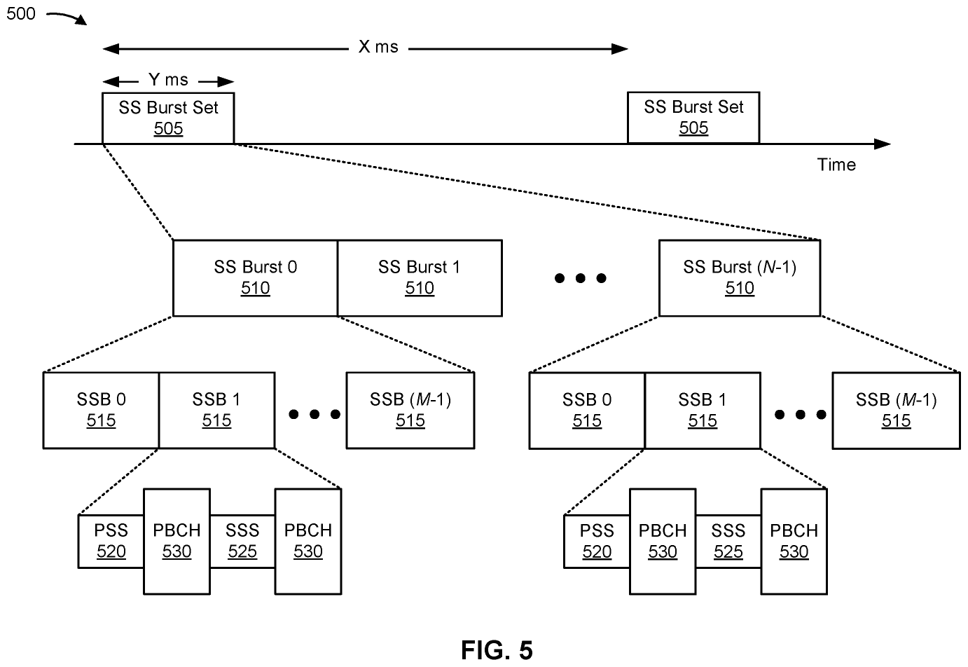

FIG. 5 is a diagram illustrating an example 500 of a synchronization signal (SS) hierarchy, in accordance with the present disclosure. As shown in FIG. 5, the SS hierarchy may include an SS burst set 505, which may include multiple SS bursts 510, shown as SS burst 0 through SS burst N−1, where N is a maximum number of repetitions of the SS burst 510 that may be transmitted by a network entity. As further shown, each SS burst 510 may include one or more SSBs 515, shown as SSB 0 through SSB M−1, where M is a maximum number of SSBs 515 that can be carried by an SS burst 510. Different SSBs 515 may be beam-formed differently (e.g., transmitted using different beams), and may be used for cell search, cell acquisition, beam management, and/or beam selection (e.g., as part of an initial network access procedure). An SS burst set 505 may be periodically transmitted by a wireless node (e.g., a network entity), such as every X milliseconds, as shown in FIG. 5. An SS burst set 505 may have a fixed or dynamic length, shown as Y milliseconds in FIG. 5. In some cases, an SS burst set 505 or an SS burst 510 may be referred to as a discovery reference signal (DRS) transmission window or an SSB measurement time configuration (SMTC) window.

An SSB 515 may include resources that carry a PSS 520, an SSS 525, and/or a physical broadcast channel (PBCH) 530. Multiple SSBs 515 may be included in an SS burst 510 (e.g., with transmission on different beams), and the PSS 520, the SSS 525, and/or the PBCH 530 may be the same across each SSB 515 of the SS burst 510. A single SSB 515 may be included in an SS burst 510. The SSB 515 may be at least four symbols (e.g., OFDM symbols) in length, where each symbol carries one or more of the PSS 520 (e.g., occupying one symbol), the SSS 525 (e.g., occupying one symbol), and/or the PBCH 530 (e.g., occupying two symbols). An SSB 515 may be referred to as an SS/PBCH block.

The symbols of an SSB 515 are consecutive, as shown in FIG. 5. The symbols of an SSB 515 are non-consecutive. Similarly, one or more SSBs 515 of the SS burst 510 may be transmitted in consecutive radio resources (e.g., consecutive symbols) during one or more slots. Additionally, or alternatively, one or more SSBs 515 of the SS burst 510 may be transmitted in non-consecutive radio resources.

The SS bursts 510 may have a burst period, and the SSBs 515 of the SS burst 510 may be transmitted by a wireless node (e.g., a network entity) according to the burst period. In this case, the SSBs 515 may be repeated during each SS burst 510. The SS burst set 505 may have a burst set periodicity, whereby the SS bursts 510 of the SS burst set 505 are transmitted by the wireless node according to the fixed burst set periodicity. In other words, the SS bursts 510 may be repeated during each SS burst set 505.

An SSB 515 may include an SSB index, which may correspond to a beam used to carry the SSB 515. A UE 120 may monitor for and/or measure SSBs 515 using different receive (Rx) beams during an initial network access procedure and/or a cell search procedure, among other examples. Based on the monitoring and/or measuring, the UE 120 may indicate one or more SSBs 515 with a best signal parameter (e.g., an RSRP parameter) to a network entity. The network entity and the UE 120 may use the one or more indicated SSBs 515 to select one or more beams to be used for communication between the network entity and the UE 120 (e.g., for a RACH procedure). Additionally, or alternatively, the UE 120 may use the SSB 515 and/or the SSB index to determine a cell timing for a cell via which the SSB 515 is received (e.g., a serving cell).

As indicated above, FIG. 5 is provided as an example. Other examples may differ from what is described with regard to FIG. 5.

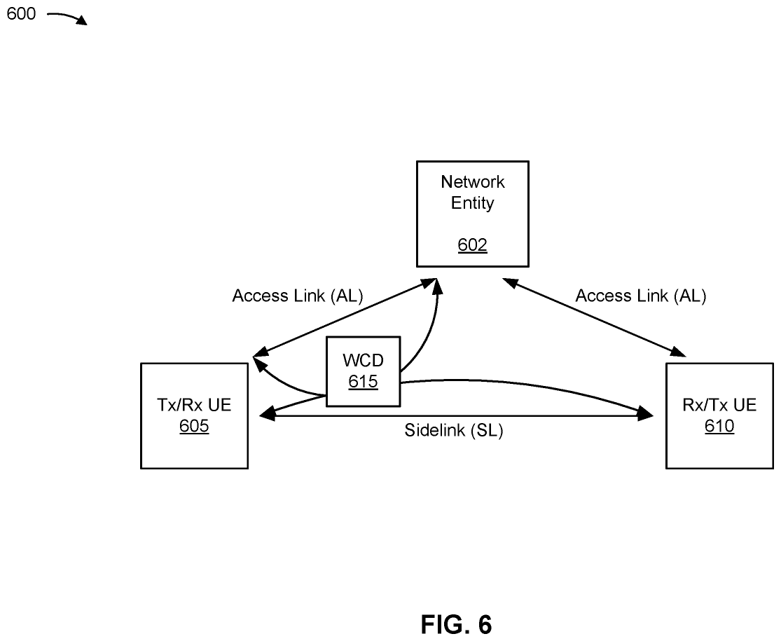

FIG. 6 is a diagram illustrating an example 600 of sidelink communications and access link communications in the presence of an intercepting communication device, in accordance with the present disclosure.

As shown in FIG. 6, a transmitter (Tx)/receiver (Rx) UE 605 and an Rx/Tx UE 610 may communicate with one another via a sidelink, as described above in connection with FIG. 5. As further shown, in some sidelink modes, a network entity 602 may communicate with the Tx/Rx UE 605 via a first access link. Additionally, or alternatively, in some sidelink modes, the network entity 602 may communicate with the Rx/Tx UE 610 via a second access link. The Tx/Rx UE 605 and/or the RxTx UE 610 may correspond to one or more UEs described elsewhere herein, such as the UE 120 of FIG. 1. Thus, a direct link between UEs 120 (e.g., via a PC5 interface) may be referred to as a sidelink, and a direct link between a network entity 602 and a UE 120 (e.g., via a Uu interface) may be referred to as an access link. Sidelink communications may be transmitted via the sidelink, and access link communications may be transmitted via the access link. An access link communication may be either a downlink communication (from a network entity 602 to a UE 120) or an uplink communication (from a UE 120 to a network entity 602).

As further shown in FIG. 6, an intercepting wireless communication device 615 may be within a communication path between Tx/Rx UE 605 and RxTx UE 610 or network entity 602. In other words, intercepting wireless communication device 615 may eavesdrop on communications between Tx/Rx UE 605 and Rx/Tx UE 610 or between Tx/Rx UE 605 and network entity 602.

As indicated above, FIG. 6 is provided as an example. Other examples may differ from what is described with respect to FIG. 6.

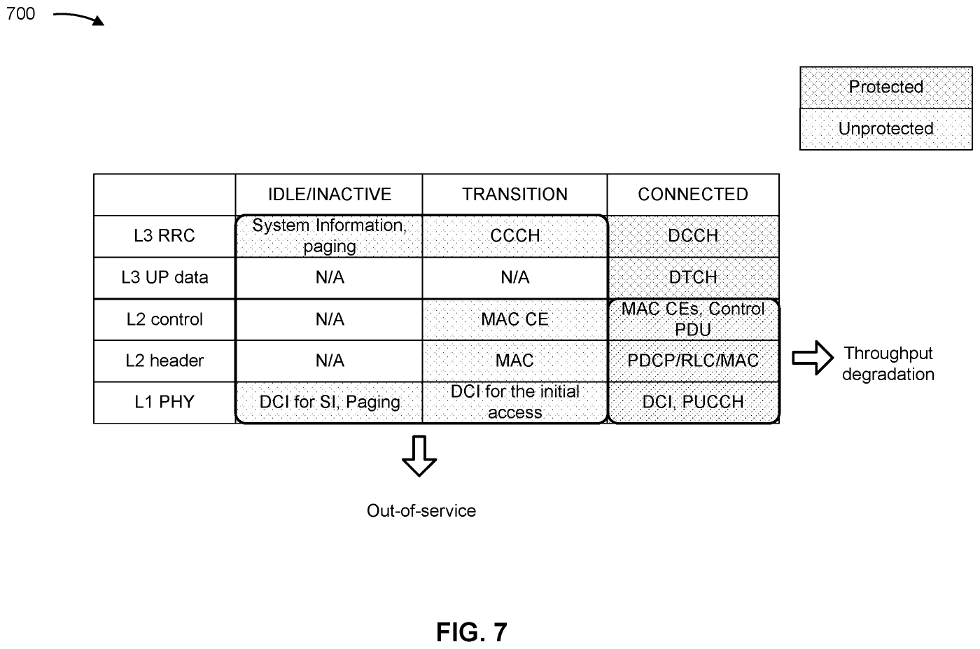

FIG. 7 is a diagram illustrating an example 700 of intercepted communications in different communication states, in accordance with the present disclosure.

A UE, such as the UE 120, may, when communicating with a network entity, such as the network entity 302, 402, or 602, operate in one or more communication states. For example, the UE may operate in an idle or inactive mode or connected mode. Additionally, a transition mode may be defined when the UE is transitioning between the idle or inactive mode and the connected mode. The UE may facilitate secure communications with the network entity (or when operating on a sidelink, with another UE) by encrypting data before transmission.

In some wireless communication systems, the UE may be configured to encrypt data at L3 (e.g., RRC data associated with a dedicated control channel (DCCH) or uplink data associated with a dedicated transport channel (DTCH)) when operating in a connected mode. Such data may be classified as protected by L3 level encryption. In contrast, the UE may not encrypt L3 system information or paging transmissions (e.g., when the UE is operating in an idle mode) and other DCCH transmissions (e.g., when the UE is transitioning between modes). Similarly, as shown, the UE may not encrypt L2 or L1 information (e.g., MAC control element (CE) (MAC-CE) data, MAC data, DCI, etc.) in the idle or inactive mode, the connected mode, or a transition mode therebetween. An intercepting wireless communication device may simulate operation of a network entity, thereby gaining access to unencrypted L1 to L3 data and causing the UE to go out of service when the UE is operating in the idle or inactive mode or the transition mode. Similarly, the intercepting wireless communication device may gain access to unencrypted L2 to L1 data and cause degraded throughput when the UE is in a connected mode.

The UE and the network entity may add encryption at a physical (PHY) layer. For example, a UE may use a security key (which may be termed a “secret key” or a “key”) and inject randomness into transmitted data. Additional detail regarding security keys is described in 3GPP Technical Specification (TS) 33.220, version 11.4.0, release 11. Different security keys may have different levels of security (e.g., robustness) and different communications may have different security requirements. A level of security of a security key may be based on a strength of a security key generation scheme (e.g., stronger security key generation scheme may result in a higher level of security of a security key). Additionally, or alternatively, the level of security of a security key may be based on a quantity of instances the security key has been used. In other words, the more a security key is used to encrypt data, the more likely it becomes that an intercepting wireless communication device may break the security key and gain access to data encrypted therewith.

As indicated above, FIG. 7 is provided as an example. Other examples may differ from what is described with respect to FIG. 7.

As described above, a network may support different levels of security to secure communications between a transmitting device and a receiving device (e.g., a UE and a network entity on an access link or a UE and another UE on a sidelink) in the potential presence of an intercepting wireless communication device. For example, in IoT deployments, many UEs may be deployed in a network and connect to each other to communicate, which may increase a likelihood that an intercepting wireless communication device can be deployed in an area to access unsecured communications.

Some UEs in IoT deployments (which may be termed “IoT devices”) may obtain electric power from sources other than wired charging or hardwiring. For example, a UE may obtain power resources, to use for communication, measurement, processing, and/or other functionalities via a radio signal, an inductive charging signal, a light beam (e.g., a laser beam), a vibration, or a temperature gradient, among other examples. For example, a network entity may be configured to transmit a wireless signal that the UE can harvest for energy, a process that may be termed energy transfer or charging. Energy transfer or charging may enable deployment of low-power UEs for extended periods of time without requiring wired charging infrastructure, thereby enabling advanced IoT use cases.

However, when a UE connects to a network (e.g., a cell of a network), a UE may determine that the network does not support a configuration to enable the UE to perform one or more functionalities associated with a use case of the UE. For example, a UE may access a network that does not support a particular security level that the UE is to use for a particular type of communication. Additionally, or alternatively, the UE may access a network that does not support energy transfer or charging when the UE is required to obtain power from energy transfer or charging or can optionally obtain power from energy transfer or charging. In these cases, the UE may disconnect from the network and search for new networks until the UE finds a network that supports a configuration to enable the UE to perform one or more functionalities associated with the use case of the UE. For example, the UE may connect to and disconnect from many networks before the UE accesses a network offering a threshold security level for communications and offering energy transfer or charging for the UE.

Some aspects described herein enable a UE and a network entity to communicate regarding a security level or an energy transfer or charging configuration in connection with an initial access procedure. For example, a network entity may provide information identifying a supported security level or energy transfer or charging rate in an SSB, a SIB, or a RACH message, among other examples. In this case, the UE may use the provided information to determine whether to attempt to connect to the network entity and access network service via the network entity. In this way, the UE avoids connecting and disconnecting from many network entities to find a network entity that satisfies a requirement of the UE, thereby reducing a utilization of power resources and/or communication resources relative to other techniques that do not provide for identifying a security level or energy transfer or charging configuration in connection with an initial access procedure.

FIG. 8 is a diagram illustrating an example 800 associated with configuration for initial access, in accordance with the present disclosure. As shown in FIG. 8, example 800 includes communication between a network entity 802 and a UE 120. In some aspects, network entity 802 and UE 120 may be included in a wireless network, such as wireless network 100. Network entity 802 and UE 120 may communicate via a wireless access link, which may include an uplink and a downlink.

As further shown in FIG. 8, and by reference number 810, UE 120 may receive information identifying a security level or an energy transfer or charging capability of a network provided by network entity 802. For example, network entity 802 may provide initial access information identifying one or more configuration parameters for a cell being provided by network entity 802. In some aspects, the initial access information may be associated with an SSB communication, a SIB communication, a 4-step RACH procedure, a 2-step RACH procedure, among other examples associated with initially accessing a network, transitioning between communication states (e.g., RRC idle or inactive states and an RRC connected state), handovers, synchronization loss recoveries, and data transmission associated with a particular communication state (e.g., data transmission in RRC idle or inactive states).

Different security levels (or “security classes”) may be configured for a network. For example, a network may be divided into a security levels with different granularities, such as a network having two security levels (e.g., low or high), a network having three security levels (e.g., low, medium, or high), or a network having any other quantity of security levels. Additionally, or alternatively, the network may have a numerical security level (e.g., a number on a close-ended scale, such as a 1-100 scale, or a number on an open-ended scale), such as based on an algorithm for calculating a numerical rating of a security level of a network.

In some aspects, such an algorithm (or any other method for determining a security level, such as a lookup table) may be based on a set of factors. For example, a security level may be based on a strength of a security technique used in securing transmission on a network (e.g., which may be based on a type of security algorithm, a length of a key, etc.). Additionally, or alternatively, the security level may be based on a type of security, such as physical (PHY) layer security using PHY layer secret key extraction having a different security level than PHY layer security using upper layer secrete key sharing. Similarly, different PHY layer secrete key extraction methods or secret key sharing methods may have different security levels. Additionally, or alternatively, the security level may be based on which type of transmission is being secured (e.g., on a PHY channel), such as whether downlink control information (DCI) is being secured, uplink control information (UCI) is being secured, a physical downlink shared channel (PDSCH) or physical uplink shared channel (PUSCH) (e.g., which may be subject to layer 3 (L3) security and additional PHY layer security) is being secured, or some combination thereof is being secured. Additionally, or alternatively, the security level may be based on whether network entity 802 is to add PHY layer authentication or signature usage to a codebook, codebook group, or transport block.

Additionally, or alternatively, the security level may be based on whether security is provided by one or more UEs 120 on a sidelink and/or which channels are available on the sidelink (e.g., a physical sidelink control channel (PSSCH), a physical sidelink feedback channel (PSFCH), a physical sidelink shared channel (PSSCH), sidelink control information (SCI) type 2 (SCI-2) on a PSSCH with L3 security, or a combination thereof may result in different levels of security). In this case, network entity 802 may have PHY security for sidelink resources configured (e.g., sidelink reference signals for PHY layer secret key extraction or sidelink resources for secret key sharing from a PHY layer or upper layer). Additionally, or alternatively, the security level may be based on for which interfaces PHY layer security is configured, such as PHY layer security being configured for a sidelink interface, a Uu link interface, or a combination thereof. In some aspects, network entity 802 and/or UE 120 may have use an algorithm, lookup table, or other technique to weigh and/or evaluate a set of factors to determine a security level and/or classify a network into a particular security level.

In some aspects, UE 120 may receive information indicating a particular attribute of or for calculating the security level (e.g., a value for a parameter or factor for determining a security level of a network). For example, UE 120 may receive information indicating a security level of a security key used for secure communications on a network provided by network entity 802 (e.g., which UE 120 may use, in combination with an algorithm, lookup table, or other technique to weigh and/or evaluate a security level of the network). Additionally, or alternatively, UE 120 may receive information indicating a plurality of possible security levels that UE 120 may use for the network provided by network entity 802. For example, UE 120 may receive information indicating that the network can be a first security level (e.g., a high security level) in connection with a first set of factors (e.g., when sidelink communications are disabled) and a second security level in connection with a second set of factors (e.g., when sidelink communications are enabled). Additionally, or alternatively, UE 120 may receive information indicating a layer of security that is provided, such as PHY layer security, for the network provided by network entity 802. In this case, UE 120 may receive information indicating that PHY layer security is provided or a type of PHY layer security that is provided (as described above), among other examples. Additionally, or alternatively, UE 120 may receive information indicating whether a network supports dedicated energy transfer or charging resources (e.g., a dedicated set of time resources, frequency resources, bands, or bandwidth parts, among other examples for wireless charging).

In some aspects, UE 120 may receive information indicating a particular attribute of the energy transfer or charging capability. For example, UE 120 may receive information indicating whether energy transfer or charging is available, a rate of energy transfer or charging (e.g., a total rate or a rate per type), a type of energy transfer or charging that is available (e.g., radio frequency (RF) energy based charging or light beam energy based charging), or a frequency of a signal for energy transfer or charging, among other examples. In some aspects, UE 120 may receive information identifying (or enabling UE 120 to determine) an energy transfer or charging level or energy transfer or charging class (e.g., which may correspond to a rate of energy transfer or charging, an ability to maintain the rate of energy transfer or charging in connection with one or more factors, such as a quantity of devices using energy transfer or charging, or a set of links for which energy transfer or charging is supported, such as a Uu link, a sidelink, or a combination thereof, among other examples). In some aspects, UE 120 may receive information identifying the security level, the energy transfer or charging capability, both the security level and the energy transfer or charging capability, another parameter or, or any combination thereof.

In some aspects, UE 120 may be an in-coverage UE and network entity 802 may provide information identifying the one or more configuration parameters in a particular type of message associated with initial access. For example, an in-coverage UE 120 may communicate with network entity 802 via an access link (e.g., the Uu link), and may receive information identifying a security level or an energy transfer or charging capability via an SSB message and/or in a PBCH master information block (MIB) communication. Additionally, or alternatively, UE 120 may receive the information identifying the security level or the energy transfer or charging capability in a SIB message, such as a SIB type 1 (SIB1) of a PDSCH, a SIB1 of a PDCCH (e.g., in DCI), or in another SIB message (e.g., another type of SIB message, other than SIB1, of a PDCCH or PDSCH). Additionally, or alternatively, UE 120 may receive the information identifying the security level or the energy transfer or charging capability in a RACH message, such as a msg2 or RAR of a PDCCH or PDSCH or an msg4 of PDCCH (e.g., DCI) or a PDSCH for 4-step RACH or a msgB of a PDCCH (e.g., DCI) or a PDSCH for 2-step RACH.

In some aspects, UE 120 may be an out-of-coverage UE that receives information indicating a security level or an energy transfer or charging capability. For example, UE 120 may receive, via a sidelink connection to an in-coverage UE (e.g., directly or via one or more other out-of-coverage UEs), information indicating the security level or charging capability shared in connection with an SSB communication.

In some aspects, UE 120 may signal a requested, desired, or required network configuration. For example, UE 120 may transmit information identifying a security level or an energy transfer or charging capability that the UE 120 can optionally use or is required to use (e.g., based on a type of UE 120 or a service provided by UE 120, among other examples) in a msg3 PUSCH message of a 4-step RACH or a msgA PUSCH message of a two-step RACH. As an example, UE 120 may transmit information indicating that UE 120 is capable of receiving energy transfer via RF based energy transfer or light beam based energy transfer, a rate at which UE 120 is configured to receive energy transfer via one or each type of energy transfer, or a rate at which UE 120 is requesting or requiring energy transfer via one or each type of energy transfer, among other examples. In this case, network entity 802 may transmit information indicating whether UE 120 is or will be allowed to connect to a network provided by network entity 802 (e.g., in a msg4 or msgB) based on whether the network satisfies the requested, desired, or required network configuration.

As further shown in FIG. 8, and by reference numbers 820 and 830, UE 120 may select a cell for access and connect to network entity 802 for access. For example, based on receiving information indicating that network entity 802 is providing a network or cell associated with a threshold security level or a threshold energy transfer or charging capability (e.g., a threshold energy transfer or charging rate), UE 120 may select network entity 802 and connect to network entity 802 to obtain network access and/or energy transfer or charging. Additionally, or alternatively, based on UE 120 indicating a requested, desired, or required network configuration, network entity 802 may grant access to a network to UE 120 to allow UE 120 to obtain network access and/or energy transfer or charging. In this case, UE 120 may receive a transfer of energy (e.g., charging) from network entity 802 (or a component thereof or associated therewith dedicated to providing the transfer of energy). For example, UE 120 may receive RF energy, light energy, or any other type of energy transfer from network entity 802 or a component associated thereof or associated therewith.

As indicated above, FIG. 8 is provided as an example. Other examples may differ from what is described with respect to FIG. 8.

FIG. 9 is a diagram illustrating an example process 900 performed, for example, by a network node, in accordance with the present disclosure. Example process 900 is an example where the network node (e.g., UE 120) performs operations associated with configuration information for initial access.

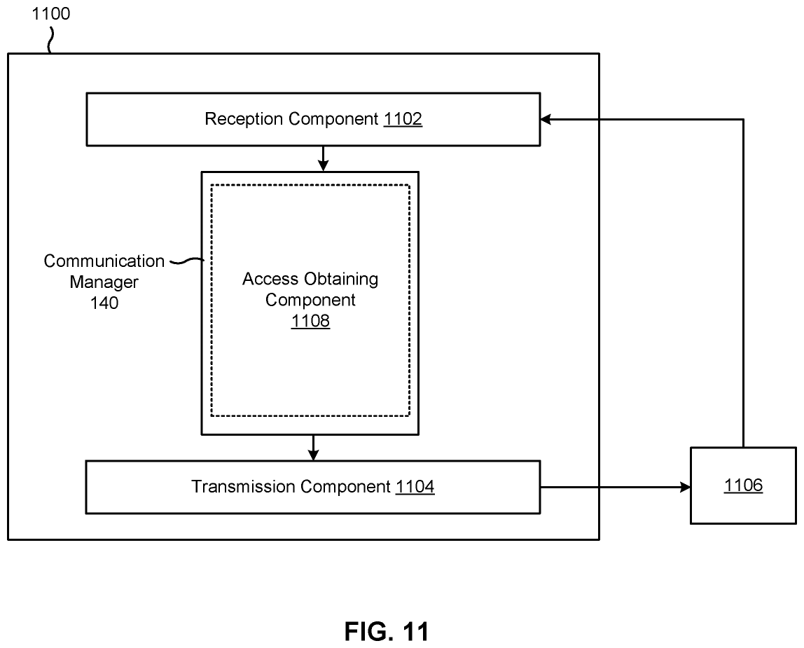

As shown in FIG. 9, in some aspects, process 900 may include receiving, from a network entity in connection with an access procedure, information indicative of at least one of a security capability or an energy transfer or charging capability (block 910). For example, the network node (e.g., using communication manager 140 and/or reception component 1102, depicted in FIG. 11) may receive, from a network entity in connection with an access procedure, information indicative of at least one of a security capability or an energy transfer or charging capability, as described above.

As further shown in FIG. 9, in some aspects, process 900 may include connecting to the network entity to obtain network access based on the security capability or the energy transfer or charging capability (block 920). For example, the network node (e.g., using communication manager 140 and/or access obtaining component 1108, depicted in FIG. 11) may connect to the network entity to obtain network access based on the security capability or the energy transfer or charging capability, as described above.

Process 900 may include additional aspects, such as any single aspect or any combination of aspects described below and/or in connection with one or more other processes described elsewhere herein.

In a first aspect, receiving the information indicative of at least one of the security capability or the energy transfer or charging capability comprises receiving information identifying the security capability.

In a second aspect, alone or in combination with the first aspect, receiving the information indicative of at least one of the security capability or the energy transfer or charging capability comprises receiving information identifying the energy transfer or charging capability.

In a third aspect, alone or in combination with one or more of the first and second aspects, the network node is an in-coverage network node and wherein receiving the information indicative of at least one of the security capability or the energy transfer or charging capability comprises receiving, via an access link, the information indicative of at least one of the security capability or the energy transfer or charging capability via at least one of a synchronization signal block, a physical broadcast channel, a master information block, a system information block, a physical downlink shared channel, a physical downlink control channel, downlinking control information, a random access channel message, or a random access channel response message.

In a fourth aspect, alone or in combination with one or more of the first through third aspects, process 900 includes transmitting information identifying a security configuration or an energy transfer or charging configuration of the network node, and wherein connecting to the network entity comprises connecting to the network entity based on the security configuration or the energy transfer or charging configuration.

In a fifth aspect, alone or in combination with one or more of the first through fourth aspects, the network node is an out-of-coverage network node, and wherein receiving the information indicative of at least one of the security capability or the energy transfer or charging capability comprises receiving, via a sidelink, the information indicative of at least one of the security capability or the energy transfer or charging capability via at least one of a synchronization signal block, or a physical broadcast channel.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a network entity, in accordance with the present disclosure. Example process 1000 is an example where the network entity (e.g., network entities 302, 402, 602, or 802, among other examples) performs operations associated with configuration information for initial access.

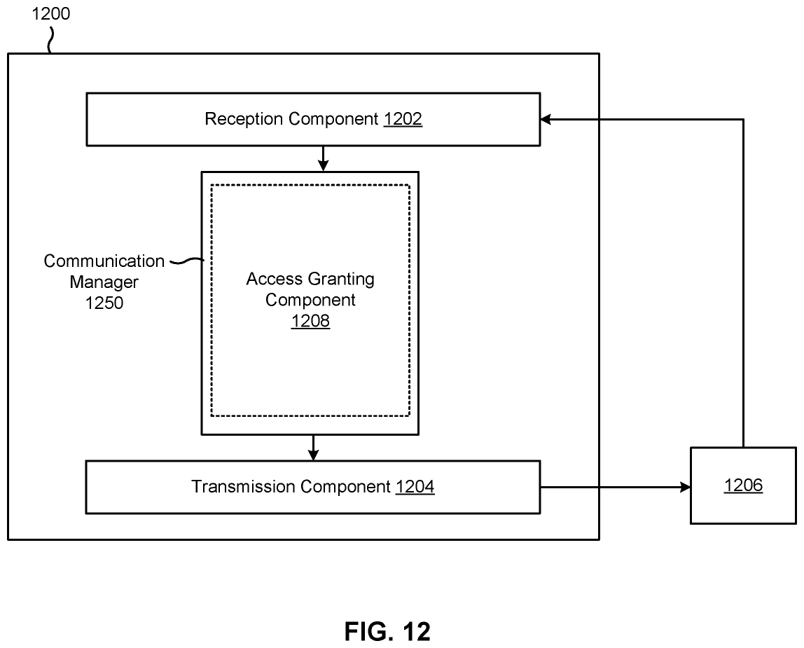

As shown in FIG. 10, in some aspects, process 1000 may include transmitting, to a network node in connection with an access procedure, information indicative of at least one of a security capability or an energy transfer or charging capability (block 1010). For example, the network entity (e.g., using communication manager 1250 and/or transmission component 1204, depicted in FIG. 12) may transmit, to a network node in connection with an access procedure, information indicative of at least one of a security capability or an energy transfer or charging capability, as described above.

As further shown in FIG. 10, in some aspects, process 1000 may include connecting to the network node to provide network access based on the security capability or the energy transfer or charging capability (block 1020). For example, the network entity (e.g., using communication manager 1250 and/or access granting component 1208, depicted in FIG. 12) may connect to the network node to provide network access based on the security capability or the energy transfer or charging capability, as described above.

Process 1000 may include additional aspects, such as any single aspect or any combination of aspects described below and/or in connection with one or more other processes described elsewhere herein.

In a first aspect, transmitting the information indicative of at least one of the security capability or the energy transfer or charging capability comprises transmitting information identifying the security capability.

In a second aspect, alone or in combination with the first aspect, transmitting the information indicative of at least one of the security capability or the energy transfer or charging capability comprises transmitting information identifying the energy transfer or charging capability.

In a third aspect, alone or in combination with one or more of the first and second aspects, the network node is an in-coverage network node and wherein transmitting the information indicative of at least one of the security capability or the energy transfer or charging capability comprises transmitting, via an access link, the information indicative of at least one of the security capability or the energy transfer or charging capability via at least one of a synchronization signal block, a physical broadcast channel, a master information block, a system information block, a physical downlink shared channel, a physical downlink control channel, downlinking control information, a random access channel message, or a random access channel response message.

In a fourth aspect, alone or in combination with one or more of the first through third aspects, process 1000 includes receiving information identifying a security configuration or an energy transfer or charging configuration of the network node, and wherein connecting to the network node comprises connecting to the network node based on the security configuration or the energy transfer or charging configuration.

In a fifth aspect, alone or in combination with one or more of the first through fourth aspects, the network node is an out-of-coverage network node, and wherein transmitting the information indicative of at least one of the security capability or the energy transfer or charging capability comprises transmitting the information indicative of at least one of the security capability or the energy transfer or charging capability via at least one of a synchronization signal block, or a physical broadcast channel.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a network node, or a network node may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, a network entity, or another wireless communication device) using the reception component 1102 and the transmission component 1104. As further shown, the apparatus 1100 may include the communication manager 140. The communication manager 140 may include an access obtaining component 1108, among other examples.

In some aspects, the apparatus 1100 may be configured to perform one or more operations described herein in connection with FIG. 8. Additionally, or alternatively, the apparatus 1100 may be configured to perform one or more processes described herein, such as process 900 of FIG. 9. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The reception component 1102 may receive, from a network entity in connection with an access procedure, information indicative of at least one of a security capability or an energy transfer or charging capability. The access obtaining component 1108 may connect to the network entity to obtain network access based on the security capability or the energy transfer or charging capability.

The transmission component 1104 may transmit information identifying a security configuration or an energy transfer or charging configuration of the network node.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a network entity, or a network entity may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 1250 (e.g., which may correspond to the communication manager 150). The communication manager 1250 may include an access granting component 1208, among other examples.

In some aspects, the apparatus 1200 may be configured to perform one or more operations described herein in connection with FIG. 8. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the base station described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the base station described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the base station described in connection with FIG. 2. In some aspects, the transmission component 1204 may be co-located with the reception component 1202 in a transceiver.

The transmission component 1204 may transmit, to a network node in connection with an access procedure, information indicative of at least one of a security capability or an energy transfer or charging capability. The access granting component 1208 may connect to the network node to provide network access based on the security capability or the energy transfer or charging capability. The transmission component 1204 may transmit information identifying a security configuration or an energy transfer or charging configuration of the network node.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

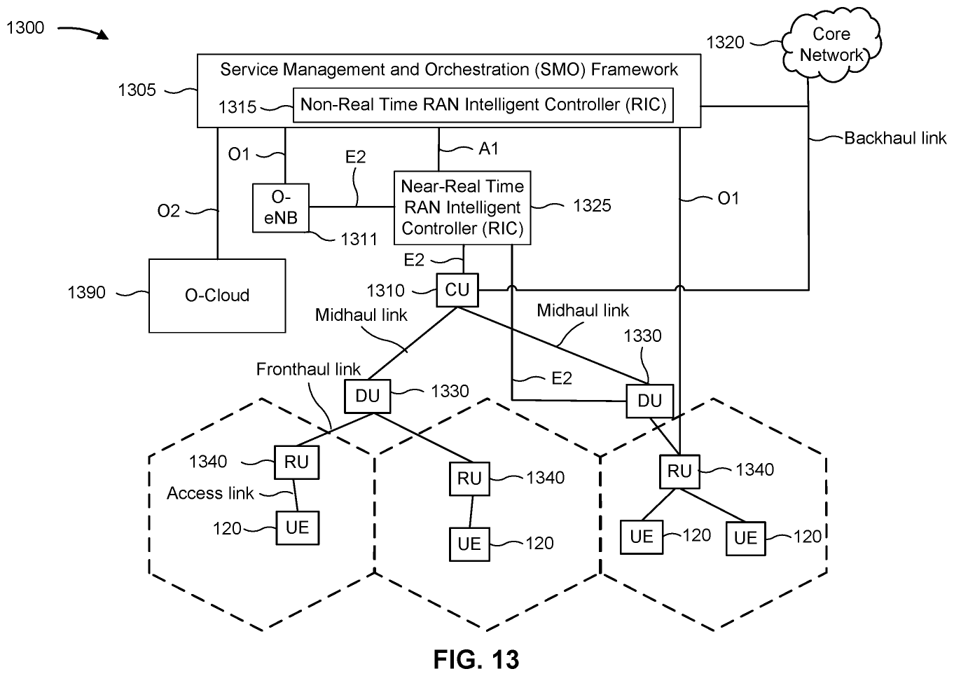

FIG. 13 shows an example of a disaggregated base station architecture 1300. The disaggregated base station architecture 1300 shown in FIG. 13 may include one or more CUs 1310 that can communicate directly with a core network 1320 via a backhaul link, or indirectly with the core network 1320 through one or more disaggregated base station units (such as a Near-Real Time (Near-RT) RAN Intelligent Controller (RIC) 1325 via an E2 link, or a Non-Real Time (Non-RT) RIC 1315 associated with a Service Management and Orchestration (SMO) Framework 1305, or both). A CU 1310 may communicate with one or more DUs 1330 via respective midhaul links, such as an F1 interface. The DUs 1330 may communicate with one or more RUs 1340 via respective fronthaul links. The RUs 1340 may communicate with respective UEs 120 via one or more radio frequency (RF) access links. In some implementations, the UE 120 may be simultaneously served by multiple RUs 1340.

Each of the units (e.g., the CUs 1310, the DUs 1330, the RUs 1340), as well as the Near-RT RICs 1325, the Non-RT RICs 1315, and the SMO Framework 1305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as an RF transceiver), configured to receive or transmit signals, or both, over a wireless transmission medium to one or more of the other units.

In some aspects, the CU 1310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 1310. The CU 1310 may be configured to handle user plane functionality (e.g., Central Unit—User Plane (CU-UP)), control plane functionality (e.g., Central Unit—Control Plane (CU-CP)), or a combination thereof. In some implementations, the CU 1310 can be logically split into one or more CU-UP units and one or more CU-CP units. The CU-UP unit can communicate bidirectionally with the CU-CP unit via an interface, such as the E1 interface when implemented in an O-RAN configuration. The CU 1310 can be implemented to communicate with the DU 1330, as necessary, for network control and signaling.

The DU 1330 may correspond to a logical unit that includes one or more base station functions to control the operation of one or more RUs 1340. In some aspects, the DU 1330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 1330 may further host one or more low-PHY layers. Each layer (or module) can be implemented with an interface configured to communicate signals with other layers (and modules) hosted by the DU 1330, or with the control functions hosted by the CU 1310.

Lower-layer functionality can be implemented by one or more RUs 1340. In some deployments, an RU 1340, controlled by a DU 1330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based on the functional split, such as a lower layer functional split. In such an architecture, the RU(s) 1340 can be implemented to handle over the air (OTA) communication with one or more UEs 120. In some implementations, real-time and non-real-time aspects of control and user plane communication with the RU(s) 1340 can be controlled by the corresponding DU 1330. In some scenarios, this configuration can enable the DU(s) 1330 and the CU 1310 to be implemented in a cloud-based RAN architecture, such as a vRAN architecture.

The SMO Framework 1305 may be configured to support RAN deployment and provisioning of non-virtualized and virtualized network elements. For non-virtualized network elements, the SMO Framework 1305 may be configured to support the deployment of dedicated physical resources for RAN coverage requirements which may be managed via an operations and maintenance interface (such as an O1 interface). For virtualized network elements, the SMO Framework 1305 may be configured to interact with a cloud computing platform (such as an open cloud (O-Cloud) 1390) to perform network element life cycle management (such as to instantiate virtualized network elements) via a cloud computing platform interface (such as an O2 interface). Such virtualized network elements can include, but are not limited to, CUs 1310, DUs 1330, RUs 1340 and Near-RT RICs 1325. In some implementations, the SMO Framework 1305 can communicate with a hardware aspect of a 4G RAN, such as an open eNB (O-eNB) 1311, via an O1 interface. Additionally, in some implementations, the SMO Framework 1305 can communicate directly with one or more RUs 1340 via an O1 interface. The SMO Framework 1305 also may include a Non-RT RIC 1315 configured to support functionality of the SMO Framework 1305.

The Non-RT RIC 1315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 1325. The Non-RT RIC 1315 may be coupled to or communicate with (such as via an A1 interface) the Near-RT RIC 1325. The Near-RT RIC 1325 may be configured to include a logical function that enables near-real-time control and optimization of RAN elements and resources via data collection and actions over an interface (such as via an E2 interface) connecting one or more CUs 1310, one or more DUs 1330, or both, as well as an O-eNB, with the Near-RT RIC 1325.

In some implementations, to generate AI/ML models to be deployed in the Near-RT RIC 1325, the Non-RT RIC 1315 may receive parameters or external enrichment information from external servers. Such information may be utilized by the Near-RT RIC 1325 and may be received at the SMO Framework 1305 or the Non-RT RIC 1315 from non-network data sources or from network functions. In some examples, the Non-RT RIC 1315 or the Near-RT RIC 1325 may be configured to tune RAN behavior or performance. For example, the Non-RT RIC 1315 may monitor long-term trends and patterns for performance and employ AI/ML models to perform corrective actions through the SMO Framework 1305 (such as reconfiguration via O1) or via creation of RAN management policies (such as A1 policies).

As indicated above, FIG. 13 is provided as an example. Other examples may differ from what is described with regard to FIG. 13.

The following provides an overview of some Aspects of the present disclosure:

Aspect 1: A method of wireless communication performed by a network node, comprising: receiving, from a network entity in connection with an access procedure, information indicative of at least one of a security capability or an energy transfer or charging capability; and connecting to the network entity to obtain network access based on the security capability or the energy transfer or charging capability.

Aspect 2: The method of Aspect 1, wherein receiving the information indicative of at least one of the security capability or the energy transfer or charging capability comprises: receiving information identifying the security capability.

Aspect 3: The method of any of Aspects 1 to 2, wherein receiving the information indicative of at least one of the security capability or the energy transfer or charging capability comprises: receiving information identifying the energy transfer or charging capability.

Aspect 4: The method of any of Aspects 1 to 3, wherein the network node is an in-coverage network node and wherein receiving the information indicative of at least one of the security capability or the energy transfer or charging capability comprises: receiving, via an access link, the information indicative of at least one of the security capability or the energy transfer or charging capability via at least one of: a synchronization signal block, a physical broadcast channel, a master information block, a system information block, a physical downlink shared channel, a physical downlink control channel, downlink control information, a random access channel message, or a random access channel response message.

Aspect 5: The method of any of Aspects 1 to 4, further comprising: transmitting information identifying a security configuration or an energy transfer or charging configuration of the network node; and wherein connecting to the network entity comprises: connecting to the network entity based on the security configuration or the energy transfer or charging configuration.

Aspect 6: The method of any of Aspects 1 to 3, wherein the network node is an out-of-coverage network node, and wherein receiving the information indicative of at least one of the security capability or the energy transfer or charging capability comprises: receiving, via a sidelink, the information indicative of at least one of the security capability or the energy transfer or charging capability via at least one of: a synchronization signal block, or a physical broadcast channel.

Aspect 7: The method of any of Aspects 1 to 6, wherein the energy transfer or charging capability includes a capability for at least one of: radio frequency (RF) energy transfer, or light energy transfer.

Aspect 8: A method of wireless communication performed by a network entity, comprising: transmitting, to a network node in connection with an access procedure, information indicative of at least one of a security capability or an energy transfer or charging capability; and connecting to the network node to provide network access based on the security capability or the energy transfer or charging capability.

Aspect 9: The method of Aspect 8, wherein transmitting the information indicative of at least one of the security capability or the energy transfer or charging capability comprises: transmitting information identifying the security capability.

Aspect 10: The method of any of Aspects 8 to 9, wherein transmitting the information indicative of at least one of the security capability or the energy transfer or charging capability comprises: transmitting information identifying the energy transfer or charging capability.

Aspect 11: The method of any of Aspects 8 to 11, wherein the network node is an in-coverage network node and wherein transmitting the information indicative of at least one of the security capability or the energy transfer or charging capability comprises: transmitting, via an access link, the information indicative of at least one of the security capability or the energy transfer or charging capability via at least one of: a synchronization signal block, a physical broadcast channel, a master information block, a system information block, a physical downlink shared channel, a physical downlink control channel, downlink control information, a random access channel message, or a random access channel response message.

Aspect 12: The method of any of Aspects 8 to 12, further comprising: receiving information identifying a security configuration or an energy transfer or charging configuration of the network node; and wherein connecting to the network entity comprises: connecting to the network entity based on the security configuration or the energy transfer or charging configuration.

Aspect 13: The method of any of Aspects 8 to 10, wherein the network node is an out-of-coverage network node, and wherein transmitting the information indicative of at least one of the security capability or the energy transfer or charging capability comprises: transmitting the information indicative of at least one of the security capability or the energy transfer or charging capability via at least one of: a synchronization signal block, or a physical broadcast channel.

Aspect 14: The method of any of Aspects 8 to 13, wherein the energy transferor charging capability includes a capability for at least one of: radio frequency (RF) energy transfer, or light energy transfer.

Aspect 15: An apparatus for wireless communication at a device, comprising a processor, memory coupled with the processor, and instructions stored in the memory and executable by the processor to cause the apparatus to perform the method of one or more of Aspects 1-7.

Aspect 16: A device for wireless communication, comprising a memory and one or more processors coupled to the memory, the one or more processors configured to perform the method of one or more of Aspects 1-7.

Aspect 17: An apparatus for wireless communication, comprising at least one means for performing the method of one or more of Aspects 1-7.

Aspect 18: A non-transitory computer-readable medium storing code for wireless communication, the code comprising instructions executable by a processor to perform the method of one or more of Aspects 1-7.

Aspect 19: A non-transitory computer-readable medium storing a set of instructions for wireless communication, the set of instructions comprising one or more instructions that, when executed by one or more processors of a device, cause the device to perform the method of one or more of Aspects 1-7.

Aspect 20: An apparatus for wireless communication at a device, comprising a processor, memory coupled with the processor, and instructions stored in the memory and executable by the processor to cause the apparatus to perform the method of one or more of Aspects 8-14.

Aspect 21: A device for wireless communication, comprising a memory and one or more processors coupled to the memory, the one or more processors configured to perform the method of one or more of Aspects 8-14.

Aspect 22: An apparatus for wireless communication, comprising at least one means for performing the method of one or more of Aspects 8-14.

Aspect 23: A non-transitory computer-readable medium storing code for wireless communication, the code comprising instructions executable by a processor to perform the method of one or more of Aspects 8-14.

Aspect 24: A non-transitory computer-readable medium storing a set of instructions for wireless communication, the set of instructions comprising one or more instructions that, when executed by one or more processors of a device, cause the device to perform the method of one or more of Aspects 8-14.

The foregoing disclosure provides illustration and description but is neither exhaustive nor limiting of the scope of this disclosure. For example, various aspects and examples are disclosed herein, but this disclosure is not limited to the precise form in which such aspects and examples are described. Additionally, the terms aspects and examples are used interchangeably. Modifications and variations may be made in light of the above disclosure or may be acquired from practice of the aspects.

As used herein, the term “component” shall be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, any combinations thereof, or otherwise. As used herein, a “processor” is implemented in hardware and/or a combination of hardware and software. Systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art understand that software and hardware can be designed to implement techniques described herein based on this disclosure.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations do not limit the scope of this disclosure to such particular combinations or features. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” include one or more items and may be used interchangeably with “one or more.” Further, as used herein, the article “the” includes one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Also, as used herein, the phrase “based on” shall not be construed as a reference to a closed set of information, one or more conditions, one or more factors, or the like. For example, the phrase “based on A” (where “A” may be information, a condition, a factor, or the like) may be interpreted as: “based at least on A.” In other words, as used herein, the phrase “based on” shall be construed in the same manner as the phrase “based at least on” or “based at least in part on.”

What is claimed is:

1. A network node for wireless communication, comprising:
a memory; and
one or more processors coupled to the memory, wherein the one or more processors are configured to:
receive, from a network entity in connection with an access procedure, information indicative of at least one of a security capability or an energy transfer or charging capability; and
connect to the network entity to obtain network access based on the security capability or the energy transfer or charging capability.

2. The network node of claim 1, wherein the one or more processors, to receive the information indicative of at least one of the security capability or the energy transfer or charging capability, are configured to:
receive information identifying the security capability.

3. The network node of claim 1, wherein the one or more processors, to receive the information indicative of at least one of the security capability or the energy transfer or charging capability, are configured to:
receive information identifying the energy transfer or charging capability.

4. The network node of claim 1, wherein the network node is an in-coverage network node and wherein the one or more processors, to receive the information indicative of at least one of the security capability or the energy transfer or charging capability, are configured to:
receive, via an access link, the information indicative of at least one of the security capability or the energy transfer or charging capability via at least one of:
a synchronization signal block,
a physical broadcast channel,
a master information block,
a system information block,
a physical downlink shared channel,
a physical downlink control channel,
downlink control information,
a random access channel message, or
a random access channel response message.

5. The network node of claim 1, wherein the one or more processors are further configured to:
transmit information indicative of a security configuration or an energy transfer or charging configuration of the network node; and
wherein the one or more processors, to connect to the network entity, are configured to:
connect to the network entity based on the security configuration or the energy transfer or charging configuration.

6. The network node of claim 1, wherein the network node is an out-of-coverage network node, and wherein the one or more processors, to receive the information indicative of at least one of the security capability or the energy transfer or charging capability, are configured to:
receive, via a sidelink, the information indicative of at least one of the security capability or the energy transfer or charging capability via at least one of:
a synchronization signal block, or
a physical broadcast channel.

7. The network node of claim 1, wherein the energy transfer or charging capability includes a capability for at least one of:
radio frequency (RF) energy transfer, or
light energy transfer.

8. A network entity for wireless communication, comprising:
a memory; and
one or more processors, coupled to the memory, configured to:
transmit, to a network node in connection with an access procedure, information indicative of at least one of a security capability or an energy transfer or charging capability; and
connect to the network node to provide network access based on the security capability or the energy transfer or charging capability.

9. The network entity of claim 8, wherein the one or more processors, to transmit the information indicative of at least one of the security capability or the energy transfer or charging capability, are configured to:
transmit information identifying the security capability.

10. The network entity of claim 8, wherein the one or more processors, to transmit the information indicative of at least one of the security capability or the energy transfer or charging capability, are configured to:
transmit information identifying the energy transfer or charging capability.

11. The network entity of claim 8, wherein the network node is an in-coverage network node and wherein the one or more processors, to transmit the information indicative of at least one of the security capability or the energy transfer or charging capability, are to:
transmit, via an access link, the information indicative of at least one of the security capability or the energy transfer or charging capability via at least one of:
a synchronization signal block,
a physical broadcast channel,
a master information block,
a system information block,
a physical downlink shared channel,
a physical downlink control channel,
downlink control information,
a random access channel message, or
a random access channel response message.

12. The network entity of claim 8, wherein the one or more processors are further configured to:
receive information identifying a security configuration or an energy transfer or charging configuration of the network node; and
wherein the one or more processors, to connect to the network node, are configured to:
connect to the network node based on the security configuration or the energy transfer or charging configuration.

13. The network entity of claim 8, wherein the network node is an out-of-coverage network node, and wherein the one or more processors, to transmit the information indicative of at least one of the security capability or the energy transfer or charging capability are to:
transmit the information indicative of at least one of the security capability or the energy transfer or charging capability via at least one of:
a synchronization signal block, or
a physical broadcast channel.

14. The network entity of claim 8, wherein the energy transfer or charging capability includes a capability for at least one of:
radio frequency (RF) energy transfer, or
light energy transfer.

15. A method of wireless communication performed by a network node, comprising:
receiving, from a network entity in connection with an access procedure, information indicative of at least one of a security capability or an energy transfer or charging capability; and
connecting to the network entity to obtain network access based on the security capability or the energy transfer or charging capability.

16. The method of claim 15, wherein receiving the information indicative of at least one of the security capability or the energy transfer or charging capability comprises:
receiving information identifying the security capability.

17. The method of claim 15, wherein receiving the information indicative of at least one of the security capability or the energy transfer or charging capability comprises:
receiving information identifying the energy transfer or charging capability.

18. The method of claim 15, wherein the network node is an in-coverage network node and wherein receiving the information indicative of at least one of the security capability or the energy transfer or charging capability comprises:
receiving, via an access link, the information indicative of at least one of the security capability or the energy transfer or charging capability via at least one of:
a synchronization signal block,
a physical broadcast channel,
a master information block,
a system information block,
a physical downlink shared channel,
a physical downlink control channel,
downlink control information,
a random access channel message, or
a random access channel response message.

19. The method of claim 15, further comprising:
transmitting information identifying a security configuration or an energy transfer or charging configuration of the network node; and
wherein connecting to the network entity comprises:
connecting to the network entity based on the security configuration or the energy transfer or charging configuration.

20. The method of claim 15, wherein the network node is an out-of-coverage network node, and wherein receiving the information indicative of at least one of the security capability or the energy transfer or charging capability comprises:
receiving, via a sidelink, the information indicative of at least one of the security capability or the energy transfer or charging capability via at least one of:
a synchronization signal block, or
a physical broadcast channel.

21. The method of claim 15, wherein the energy transfer or charging capability includes a capability for at least one of:
radio frequency (RF) energy transfer, or
light energy transfer.

22. A method of wireless communication performed by a network entity, comprising:
transmitting, to a network node in connection with an access procedure, information indicative of at least one of a security capability or an energy transfer or charging capability; and
connecting to the network node to provide network access based on the security capability or the energy transfer or charging capability.

23. The method of claim 22, wherein transmitting the information indicative of at least one of the security capability or the energy transfer or charging capability comprises:
transmitting information identifying the security capability.

24. The method of claim 22, wherein transmitting the information indicative of at least one of the security capability or the energy transfer or charging capability comprises:
transmitting information identifying the energy transfer or charging capability.

25. The method of claim 22, wherein the network node is an in-coverage network node and wherein transmitting the information indicative of at least one of the security capability or the energy transfer or charging capability comprises:
transmitting, via an access link, the information indicative of at least one of the security capability or the energy transfer or charging capability via at least one of:
a synchronization signal block,
a physical broadcast channel,
a master information block,
a system information block,
a physical downlink shared channel,
a physical downlink control channel,
downlink control information,
a random access channel message, or
a random access channel response message.

26. The method of claim 22, further comprising:
receiving information identifying a security configuration or an energy transfer or charging configuration of the network node; and
wherein connecting to the network entity comprises:
connecting to the network entity based on the security configuration or the energy transfer or charging configuration.

27. The method of claim 22, wherein the network node is an out-of-coverage network node, and wherein transmitting the information indicative of at least one of the security capability or the energy transfer or charging capability comprises:
transmitting the information indicative of at least one of the security capability or the energy transfer or charging capability via at least one of:
a synchronization signal block, or
a physical broadcast channel.

28. The method of claim 27, wherein the energy transfer or charging capability includes a capability for at least one of:
radio frequency (RF) energy transfer, or
light energy transfer.
